(19) United States
(12) Patent Application Publication
(10) Pub. No.: US 2014/0007501 A1
(43) Pub. Date: Jan. 9, 2014

(54) SELF WATERING PLANT SYSTEM

(71) Applicant: Arthur Francis Griebel, Phoenix, AZ (US)

(72) Inventor: Arthur Francis Griebel, Phoenix, AZ (US)

(21) Appl. No.: 14/022,142

(22) Filed: Sep. 9, 2013

Related U.S. Application Data
(63) Continuation-in-part of application No. 12/641,158, filed on Dec. 17, 2009.

(51) Int. Cl. A01G 27/06; A01G 27/00

(52) U.S. Cl. CPC A01G 27/06; A01G 27/003
USPC 47/48.5

(57) ABSTRACT

This self-watering planter comprises a wick, reservoir, wick-housing running between the soil/soil substitute and the reservoir, and a tight fitting cap to maintain a vacuum seal within the reservoir. The water or liquid mixture is maintained at a constant level across the wick by the vacuum that is created. This prevents water from flowing upwards into the soil when the soil is already wet. Liquid is only drawn from the wick by osmosis when the soil is dry. Even as the water level in the reservoir drops, the water level across the wick continues to remain level until the reservoir is nearly empty, allowing the soil constant access to water until the reservoir needs refilling. Several embodiments are included. All contains these features, but some contain addition features as well as different proportions. The uses of the different embodiments are also described.

### CROSS-REFERENCE TO RELATED APPLICATION(S)

The present non-provisional patent application is a continuation-in-part of U.S. patent application Ser. No. 12/541,158, which is entitled “SELF WATERING PLANT SYSTEM”, which was filed on Aug. 13, 2009, and which is incorporated in full by reference herein.

### FIELD OF THE INVENTION

The technology described herein relates to planters and self-watering planters.

### BACKGROUND OF THE INVENTION

Non-self watering planters often require daily attention to check soil moisture and water as needed. It is also common for under and overwater to occur when the plants are not checked often enough or if too much water is given.

Several self-water planters and devices exist, but most do not adequately regulate the amount of water that is given to a plant. Wick systems tend to allow the soil to remain very wet when the reservoir is full and dry when the liquid in the reservoir runs low. Several self-water planters operate based on a vacuum, but they tend to lead to overwatering. When the filling lid is removed to fill the reservoir, water runs uncontrollable into the soil. Also typically, they rely on soil saturation to stop the flow of water.

Related patents and published patent applications known in the background art include the following: U.S. Pat. No. 4,999,947, issued to Whitaker on Mar. 18, 1991, discloses a controlled wick waterer for planter pots and the like. U.S. Pat. No. 5,046,282, issued to Whitaker on Sep. 10, 1991, discloses an automatic waterer for plants.

The foregoing patent information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

Thus, there remains a need for an apparatus and system for an improved self watering plant system. The technology described herein addresses these unmet needs.

### BRIEF SUMMARY OF THE INVENTION

In various exemplary embodiments, the technology described herein provides self-watering plant system.

In one exemplary embodiment, the technology described herein provides a self-watering plant system including: a refillable reservoir configured to store a liquid; at least one interchangeable wick; a wick holder configured to hold circumferentially the at least one interchangeable wick; and a wick housing configured to house the at least one interchangeable wick and securely couple with the wick holder.

In at least one embodiment of the self-watering plant system, the at least one interchangeable wick comprises at least two interchangeable wicks and wherein the self-watering plant system further comprises at least two wick holders and at least two wick housings disposed at least partially within the refillable reservoir.

In at least one embodiment of the self-watering plant system, the wick holder is defined as very short relative to an overall length of the at least one interchangeable wick and covers only a minimal portion circumferentially of the at least one interchangeable wick.

In at least one embodiment of the self-watering plant system, the wick holder is defined as very long relative to an overall length of the at least one interchangeable wick and covers a portion circumferentially of the at least one interchangeable wick that is a majority of the length of the at least one interchangeable wick.

In at least one embodiment of the self-watering plant system, the wick holder is defined with a wick holder length to be substantially all of a wick housing length.

In at least one embodiment of the self-watering plant system, the wick holder is defined with a wick holder length to extend beyond a wick housing length and external to the refillable reservoir.

In at least one embodiment of the self-watering plant system, the wick holder is defined with a wick holder length to extend beyond a wick housing length and external to the refillable reservoir and further extended around a portion of the at least one interchangeable wick that extends into soil contained within the self-watering plant system.

In at least one embodiment of the self-watering plant system, the wick holder is defined as non-linear.

In at least one embodiment of the self-watering plant system, the wick holder is defined as U-shaped, such that the wick holder makes a 180-degree turn.

In at least one embodiment, the self-watering plant system further includes: a first wick holder defined as linear; and a second wick holder defined as non-linear; wherein the self-watering plant system is thus configured for use above soil.

In at least one embodiment, the self-watering plant system further includes a means to apply and maintain a pressure on the at least one interchangeable wick at a location where the wick passes through an airspace between the liquid in the reservoir and the soil.

In at least one embodiment, the self-watering plant system further includes an adjustment knob, configured to adjust an amount of pressure, thereby to regulate the capillary action in the at least one interchangeable wick.

In at least one embodiment, the self-watering plant system further includes a bar which runs from the adjustment knob towards the at least one interchangeable wick.

In at least one embodiment of the self-watering plant system, the self-watering plant system does not include a wick housing.

In at least one embodiment, the self-watering plant system further includes: plurality of threads disposed on the bar, and a plurality of complementary threads disposed on adjacent edges of the planter, thereby configured to allow-pressure to be applied or removed via a screw mechanism; and an adjustment pointer, located at the end of the bar nearest the wick, that moves towards and away from the wick with the bar, thereby configured to apply and remove pressure, but not turn with the bar, thus configured to avoid damage to the wick.

In at least one embodiment, the self-watering plant system further includes: a circular end that fits with a complementary circular end on the bar, configured to allow the two parts to spin separately; and a non-circular circumference, and a non-circular complimentary passage within the planter, configured to prevent the adjustment pointer from spinning.

In at least one embodiment, the self-watering plant system further includes a cap configured to tightly seal the reservoir.

In at least one embodiment of the self-watering plant system, the wick holder fits into a planter between the at least one interchangeable wick and the wick housing; contains a wick holder ingress opening which allows a portion of the wick to be exposed to liquid in a reservoir; contains a wick holder egress opening which allows a portion of the wick to be exposed to a soil medium; and is detachable from the planter.

In at least one embodiment of the self-watering plant system, the wick holder is configured to surround a circumference of a portion of the at least one interchangeable wick and to modify an opening of the reservoir, as needed, to accommodate additional material surrounding the at least one interchangeable wick.

In at least one embodiment, the self-watering plant system further includes a second wick holder.

In at least one embodiment of the self-watering plant system, the wick housing is additionally configured to house, one at a time, wicks that are varying degrees of thickness such that a correct wick thickness is selected and utilized based on water needs of a plant watered by the self watering plant system.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a cross-sectional view of the self watering plant system, according to an embodiment of the technology described herein;

FIG. 2 is a cross sectional view of a self watering plant system having multiple wicks, according to an embodiment of the technology described herein;

FIG. 3 is a cross sectional view of a self watering plant system having interchangeable wicks for different watering needs, according to an embodiment of the technology described herein;

FIG. 4 is a cross sectional view of a self watering plant system having a water sensor, according to an embodiment of the technology described herein;

FIG. 5 is a cross sectional view of a self watering plant system having an adjustment knob to control soil wetness, according to an embodiment of the technology described herein;

FIG. 6 is a cross sectional view of the adjustment mechanism used in the self watering plant systems depicted in FIG. 5 and FIG. 7;

FIG. 7 is a perspective view of the self watering plant system depicted in FIG. 5;

FIG. 8 is a perspective view of a self watering plant system where a separate plant pot is not needed, and illustrating, in particular, an adjustment knob for watering and a mechanism for displaying the water level, according to an embodiment of the technology described herein; and

FIG. 9 is a cross sectional view of the self watering plant system depicted in FIG. 8, and illustrating, in particular, how the adjustment knob can be used when the reservoir encloses all sides of the soil, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a self watering plant system.

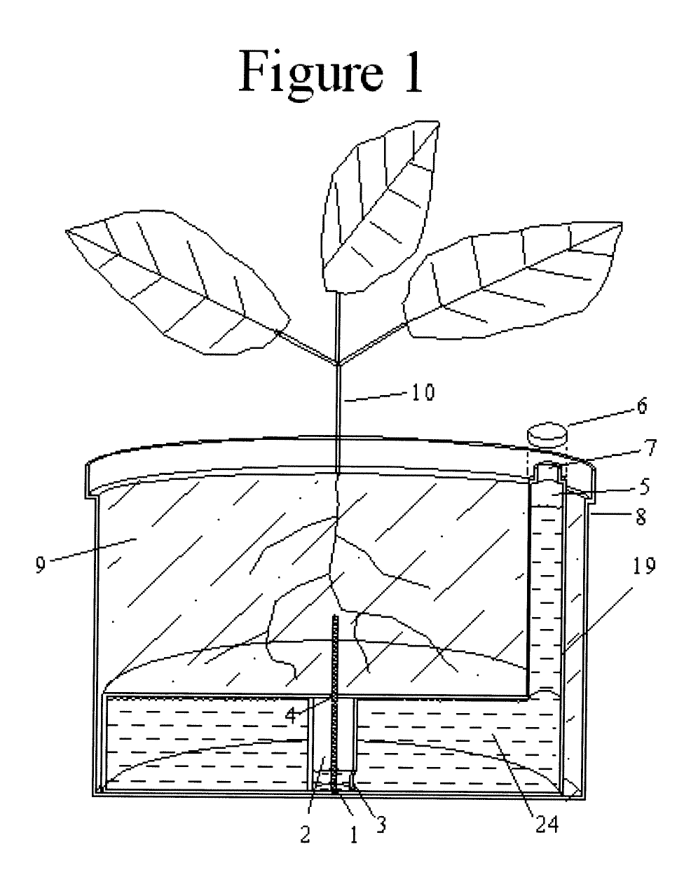

In FIG. 1, a cross sectional view, the invention is shown in an embodiment that is inserted into any standard plant pot 8. The cap 6 is removed to pour liquid 24 through the spout 7, filling the reservoir 5. During filling, water is restricted from flowing freely into the soil 9 by the diameter of the hole 4 at the top of the wick housing 2. The hole 4 should be snug around the wick 1 so that liquid 24 must flow through the wick 1 to enter the soil 9. The hole 4 should not be so tight as to pinch off the flow of liquid 24. Since the wick 1 remains wet, organic materials such as cotton is would be prone to rot. For this reason, a non-organic material is recommended for the wick 1.

When the reservoir is full and the cap 6 is used to close the spout 7, a vacuum is created and liquid 24 cannot leave the reservoir until the vacuum is broken. In order to create the vacuum, the body of the reservoir 19 must be made of a non-porous material. Also, the cap 6 must make a tight seal with the spout 7. The vacuum seal is broken routinely under normal operation when liquid 24 flows up the wick 1 into the soil 9, causing the liquid 24 inside the wick housing 2 to drop below the top of the opening 3 located in the wick housing 2. During this stage, air enters the reservoir through the opening 3, breaking the vacuum. Gravity then forces liquid 24 back into the wick housing 2. Once the liquid 24 rises above the opening 3, the vacuum seal is reestablished. The cycle repeats when water begins to flow up the wick, giving the plant 10 constant access to water as long as the reservoir contains liquid 24.

When the soil 9 becomes dry, water is absorbed at a faster rate between the wick tissue and the soil 9 due to osmosis. Likewise after the moisture between the wick 1 and the soil 9 become equal, the flow of liquid 24 stops. Water disperses throughout the soil 9 by the same capillary action that causes water to flow up the wick 1. Once the soil medium is about as moist as the wick, osmosis stops and does not continue until the plant 10 uses the moisture in the soil 9 and the soil 9 becomes dry again. In this way, the plant 10 is protected from both over and under watering.

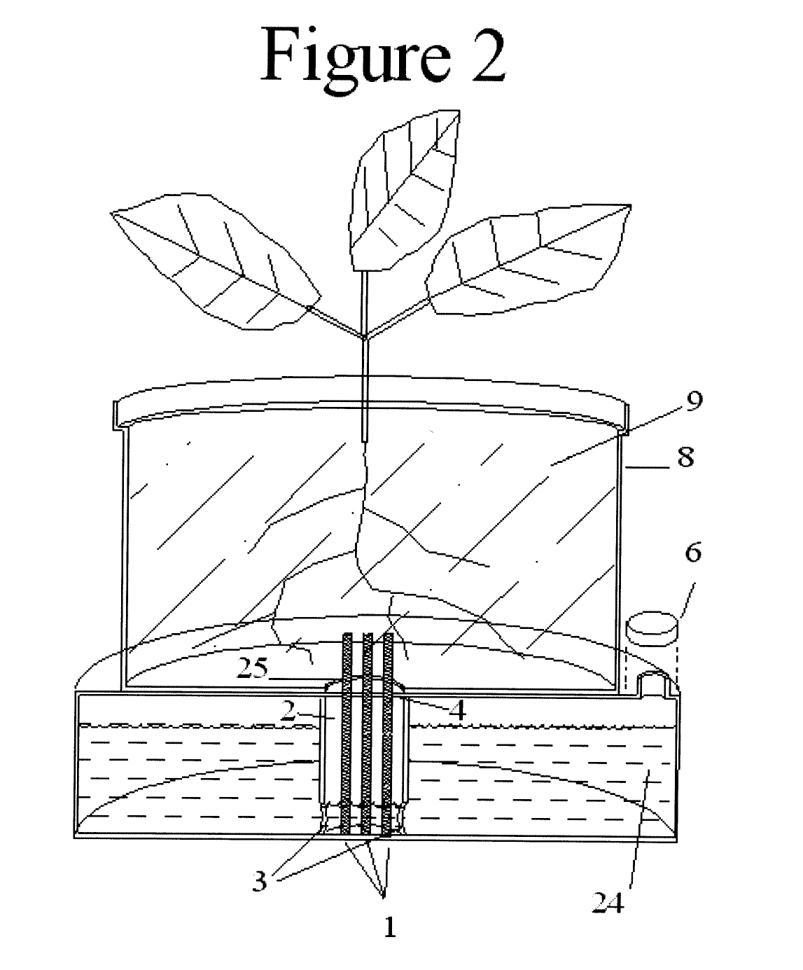

In FIG. 2, the plant pot 8 is placed directly on top of the invention with the wicks 1 running up through the drainage hole 25 at the bottom of the pot 8. This allows several plant pots 8 to be easily be swapped out on the same Self Watering Plant System without repotting.

Three wicks 1 are included in this embodiment. The purpose would be for creating a greater distribution area for liquid 24 into the soil 9 for when a sandy or other soil with poor capillary properties is used.

The flow of liquid 24 up the wick 1 is controlled by several forces. Gravity restricts the flow upwards while the capillary action of the wick 1 pulls water up along the length of the wick 1. In order to reduce the amount of moisture that is present, the force of gravity may be increased in relation to the capillary action. An embodiment with a large distance between the opening 3 at the bottom of the wick housing 2 and the hole 4 at the top of wick housing 2 offers greater resistance to the flow of liquid 24 against the force of gravity. A way to combat the force of gravity, a wick 1 with an increased diameter increases the force of the capillary action. Adjusting these features allows one embodiment of the Self Watering Plant System to keep the soil more moist than another embodiment; for instance, increasing both the wick diameter and decreasing the distance between the openings 3 and 4 on both ends of the wick housing 2 will cause greater moisture to flow into the soil 9 than if the reverse were true. This is due to the increased force of capillary action and the reduced force of gravity. By including three wicks 1 in this embodiment, there is a greater combined width of the wick 1. This also results in greater capillary action and thus wetter soil 9 than if one of the wicks 1 were used.

In order to prevent liquid 24 from flowing freely into the soil 9 when the cap 6 is removed, each wick 1 must have a separate hole 4 at the top of the wick housing 2. This embodiment includes two openings 3 at the bottom of the wick housing 2. There is no additional benefit for this when the openings 3 are of the same height. The extra opening was included in FIG. 2 to display that any number of openings may be used.

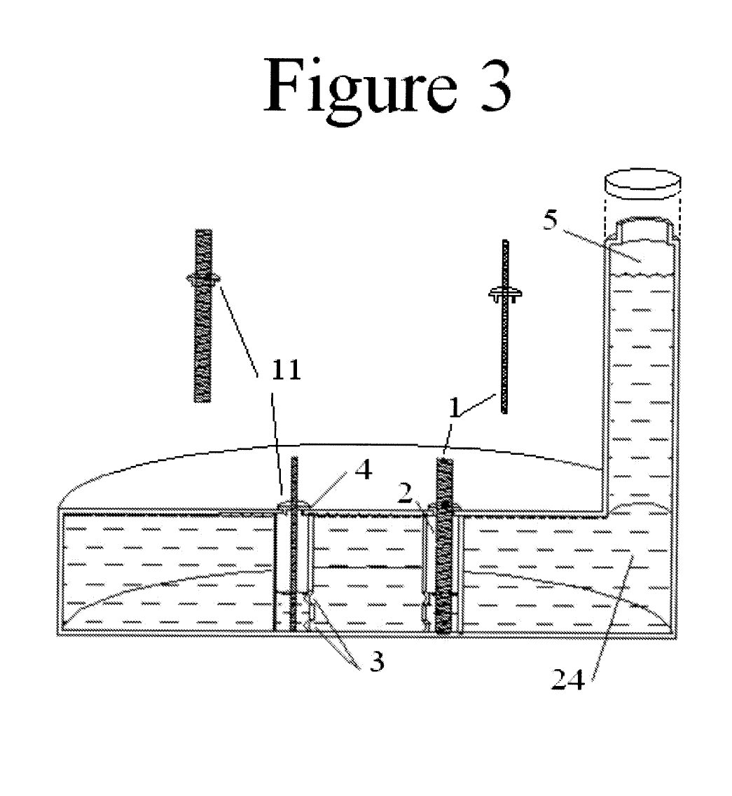

In the embodiment show in FIG. 3, two wick housings 2 are included. Each housing 2 has two openings 3 at the bottom. The lower holes 3 are flush with the bottom of the reservoir 5 so that liquid 24 will continue to flow into the wick housing 2 until the reservoir 5 is completely dry. The top opening 3 allows liquid to flow up to that level when the reservoir is full or at least the same level as the top of the top opening 3. One large opening 3 would serve the same purpose.

The benefit of using two wick housings 2 is to allow the wicks 1 to transport water into the soil at a greater distance apart. The cons of have two wick housings 2 is that when the roots of the plant 10 absorb liquid 24 more quickly out of one side of the invention, the liquid 24 may flow up both wick housings 2 when the liquid 24 has only fallen below the top of the opening 3 in one of the wick housings 2. The result is liquid rising higher than the top of opening 3 in one of the housings 2. Consequently, the side where the soil was wetter from the start will receive more watering than the side where the liquid 24 was depleted. When the two wick tubes 2 are relatively close to each other, this will be auto corrected. Water will flow more rapidly up the tube with a shorter distance between the level of the liquid 24 in the wick housing 2 and the hole 4 at the top of the housing until the liquid levels in both housings are equal. However, this results in less consistent watering. As a result several wick tubes 2 are not recommended for long planters with multiple plants.

FIG. 3 also displays another feature, interchangeable wicks 1 that are fitted using wick holder 11. In this embodiment, the hole 4 at the top of the wick housing 2 is larger than the diameter of the wick. The wick holder 11 fits snuggly into the hole 4 at the top of the wick housing 2. The center of the wick holder 11 has an opening where the wick 1 fits snuggly as well. Wicks 1 of different thicknesses fit into wick holders 11 with holes of corresponding thickness. The outer diameters of the wick holders 11 are the same so that they will fit into the same hole 4 at the top of the wick housing 2. The result is that one Self Watering Plant System may be changed out with a thin wick 1 or a thick wick 1. As described under FIG. 2, a thicker wick 1 has a greater capillary action and results in a wetter wick 1 near the soil. This allows one Self Watering Plant System to be sold for use with both water-loving plants as well as for plants requiring less moisture. The wick holder 11 may be used with an embodiment with one or several wicks 1.

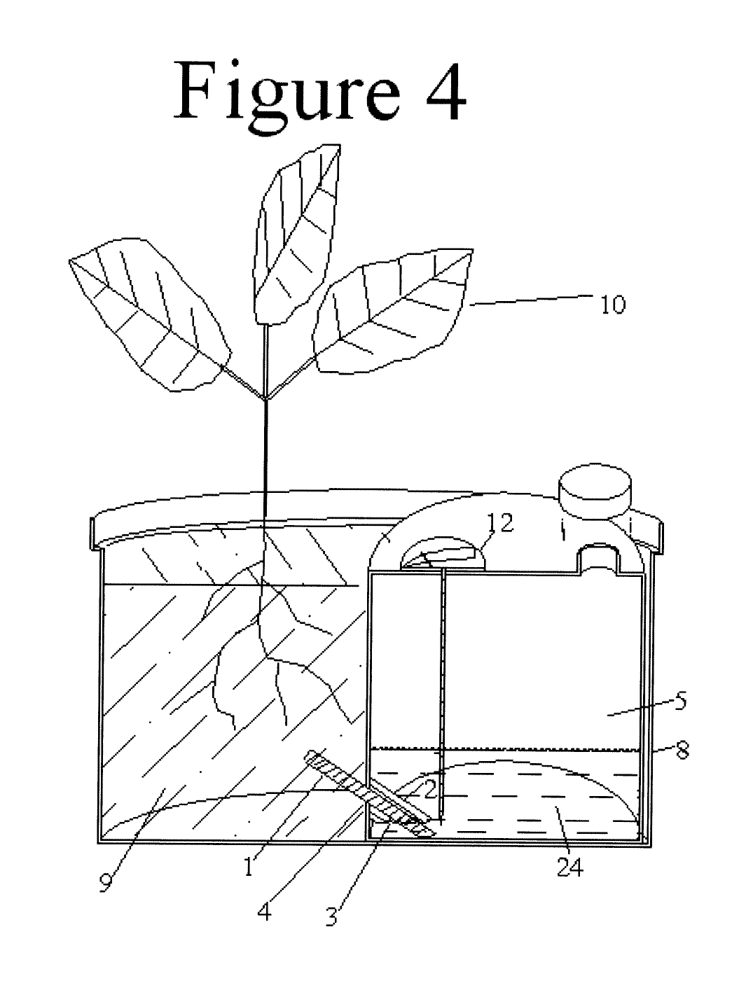

FIG. 4 shows an embodiment with a wick 1 protruding from the side of the body of the reservoir 19. The purpose is that this embodiment is easier to insert into an existing potted plant 10. Soil 9 may be removed from the side of an existing pot 8 and the invention inserted without disturbing as many roots as if soil 9 were to be removed from both the side and the bottom.

Also in this figure, the opening 3 at the bottom of the wick housing 2 faces downwards instead of on the side of the wick housing 2. Due to this, the wick housing 2 does not extend down to the bottom of the body of the reservoir 19. Watering is not affected by either placement. However, the level of the top of the opening 3 does affect watering. If the opening 3 were lower, there would be a greater distance between the lower opening 3 and the hole 4 at the top of the wick housing 2. As stated previous, this would result in increased resistance in the flow of liquid up the wick 1 and thus drier soil 9.

At the top surface of the invention, a water sensor 12 is also present in this embodiment. This is completely optional for showing the amount of liquid 24 that is present in the reservoir 5. Any existing sensor may be used, provider that the seal between the sensor 12 and the body of the reservoir 19 is airtight.

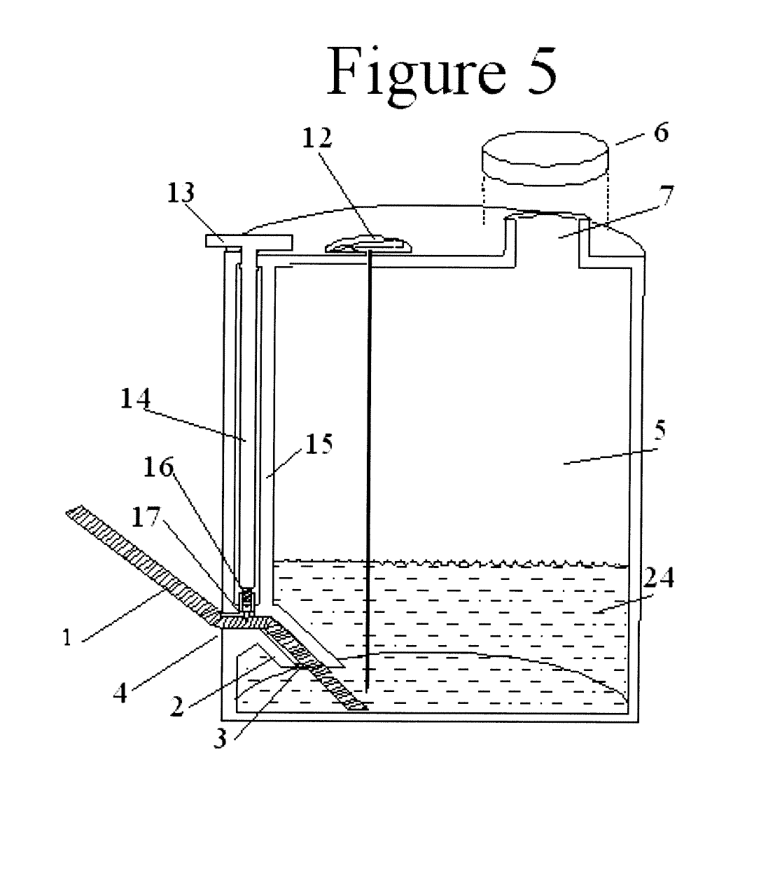

FIG. 5 is similar to FIG. 4, but with one added feature. This embodiment includes a mechanism for easily adjusting the amount of moisture present in the wick 1. Adjustment knob 13 can be turned one way to pinch the wick 1 and the other way to return the wick 1 to normal. Attached to the adjustment knob 13 is a bar 14 with threads 16 on the end nearest the wick 1. When turned, the threads 16 move the adjustment pointer 17 towards and away from the wick 1, causing the wick 1 to be pinched when the adjustment pointer 17 presses into it. The pinching has the same effect as using a wick 1 with a smaller diameter. The wick 1 will have less moisture present on the side of the wick 1 opposite of the reservoir 5 due to a decrease in capillary action. The adjustment bar housing 15 prevents liquid 24 in the reservoir 5 from contacting the wick 1 on the upper end of the adjustment pointer 17. To prevent liquid 24 from rising inside the adjustment housing 15 when the cap 6 is not securely fasted to the spout 7, the wick housing 2 must be snug against the wick 1 between the opening 3 at the bottom of the wick housing 2 and the adjustment pointer 17. The hole 4 at the top of the wick housing 2 must also be snug so that soil does not run down the wick housing 2 and interfere with the adjustment pointer 17.

As seen in FIG. 4, a water sensor 12 is also present in this embodiment. This way the user need not open the cap 6 to check if liquid 24 is remaining in the reservoir.

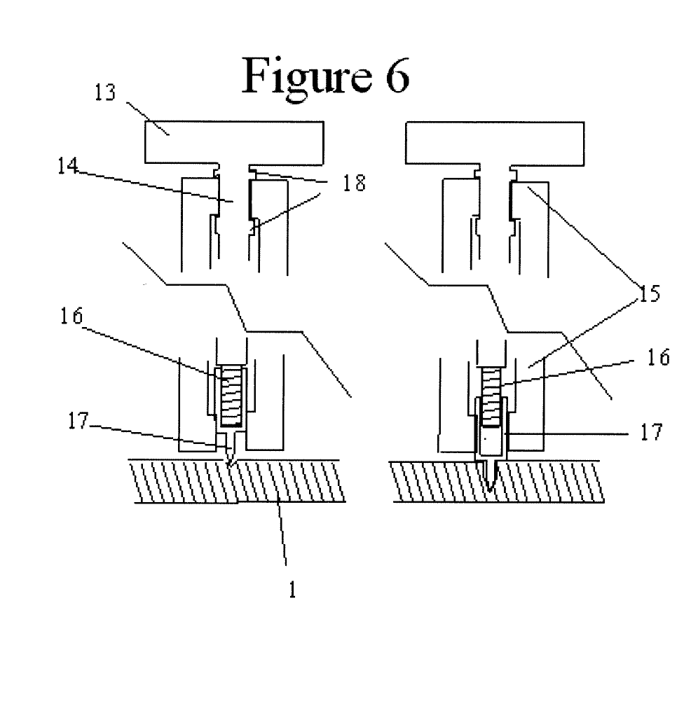

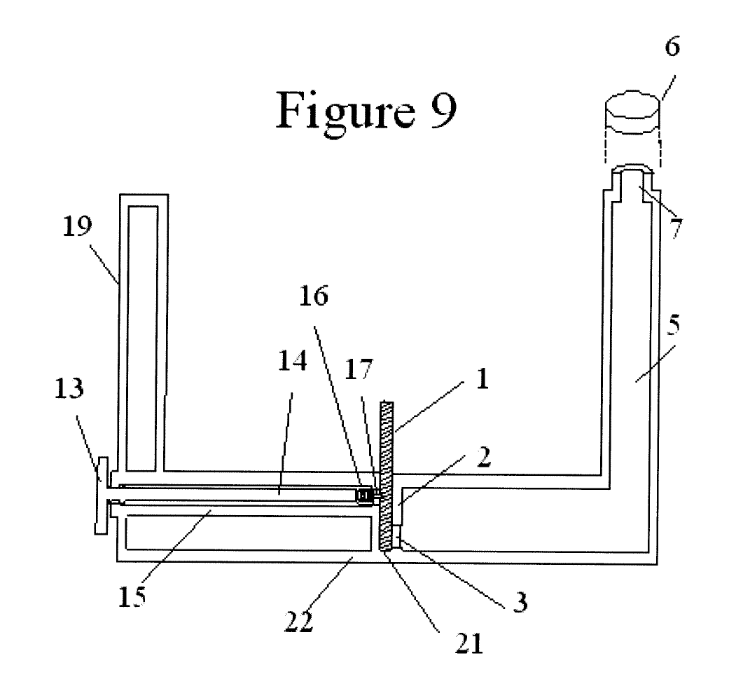

FIG. 6 shows a close up of the adjustment mechanism described in FIG. 5 as well as in FIG. 9. When the adjustment knob 13 is turned the bar 14 is also turned. A mechanism of preventing the bar from sliding in and out of the adjustment housing 15 is required. In this embodiment, two areas of increased diameter 18 around the bar 14 is used to hold the bar 14 in place. On the bar 14, threads 16 are present that fit to the adjustment pointer 17. The adjustment pointer 17 must not spin with the bar 14 in order for the threads 16 to push and pull the adjustment pointer 17. The adjustment pointer 17 is held in place in this embodiment by having a box shape. The adjustment housing 15 contains a square shaped whereby the adjustment pointer 17 fits snuggly. When the adjustment knob 13 is turned, the threads cause the adjustment pointer 17 to move up and down against the wick 1. The result is increased resistance against the flow of liquid 24 through the wick 1 when the adjustment pointer 17 is depressed.

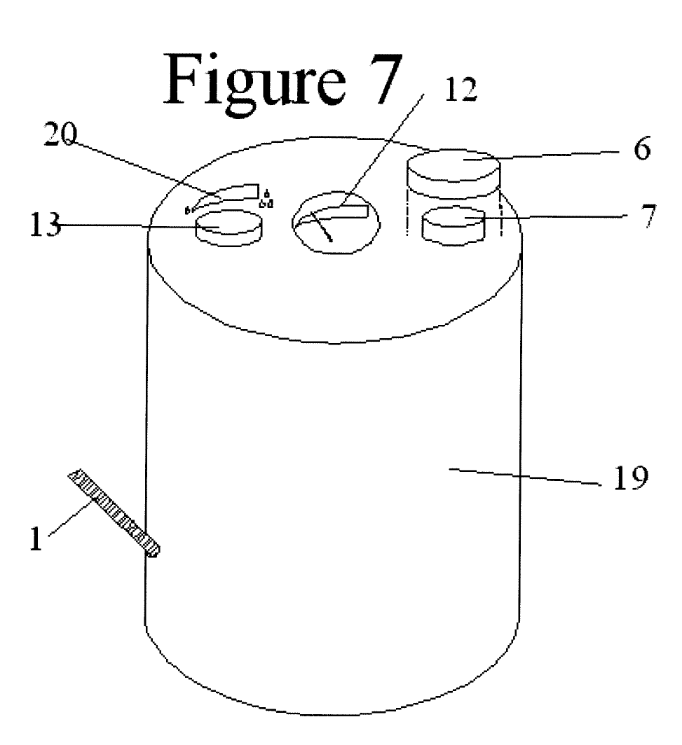

FIG. 7 shows a perspective view of the embodiment shown in FIG. 5, where 13 is the adjustment knob and 20 is an adjustment reader. The adjustment reader 20 allows the user to see if the adjustment knob 13 has been turned to increase or decrease the amount of moisture that is to be present in the wick 1. A water sensor 12, cap 6, and filling spout 7 are also present on the top wall of the body of the reservoir 19.

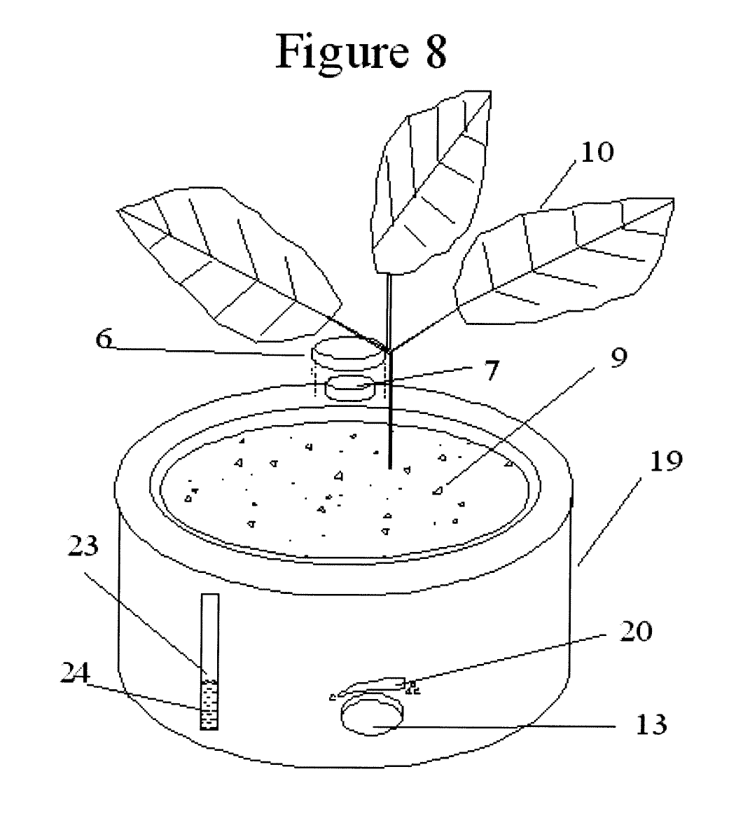

FIG. 8 is a perspective view of an embodiment where the reservoir encompasses the soil 9 on all sides as well as below the soil 9. A clear panel 23 is located on the side of the body of the reservoir 19 so that the level of the liquid 24 within the reservoir may be seen. The cap 6 and spout 7 is located at the top of the reservoir as it is in other embodiments. An adjustment knob 13 is present as well as an adjustment reader 20 so that the wetness of the soil may be altered as needed based on the needs of the plant 10.

FIG. 9 is a cross sectional view of FIG. 8, allowing for a view of the adjustment bar 14 and adjustment pointer 17. Like FIG. 5, the adjustment knob 13 turns a bar 14 and threads 16 so that the adjustment pointer 17 will compress the wick. This action will reduce the moisture present in the portion of the wick 1 that is above the adjustment pointer 17 and runs into the soil 9. Also as in FIG. 5, the wick housing 2 must be snug between the opening 3 at the bottom of the wick housing 2 and the adjustment pointer. If this is not snug, liquid will run through the adjustment housing 15, past the adjustment knob 13 and out of the side of the reservoir 19 when the cap 6 is not securely fastened to the spout 7.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the technology described herein and are intended to be covered by the following claims.

What is claimed is:

1. A self-watering plant system comprising:
a refillable reservoir configured to store a liquid;
at least one interchangeable wick;
a wick holder configured to hold circumferentially the at least one interchangeable wick; and
a wick housing configured to house the at least one interchangeable wick and securely couple with the wick holder.

2. The self-watering plant system of claim 1, wherein the at least one interchangeable wick comprises at least two interchangeable wicks and wherein the self-watering plant system further comprises at least two wick holders and at least two wick housings disposed at least partially within the refillable reservoir.

3. The self-watering plant system of claim 1, wherein the wick holder is defined as very short relative to an overall length of the at least one interchangeable wick and covers only a minimal portion circumferentially of the at least one interchangeable wick.

4. The self-watering plant system of claim 1, wherein the wick holder is defined as very long relative to an overall length of the at least one interchangeable wick and covers a portion circumferentially of the at least one interchangeable wick that is a majority of the length of the at least one interchangeable wick.

5. The self-watering plant system of claim 1, wherein the wick holder is defined with a wick holder length to be substantially all of a wick housing length.

6. The self-watering plant system of claim 1, wherein the wick holder is defined with a wick holder length to extend beyond a wick housing length and external to the refillable reservoir.

7. The self-watering plant system of claim 1, wherein the wick holder is defined with a wick holder length to extend beyond a wick housing length and external to the refillable reservoir and further extended around a portion of the at least one interchangeable wick that extends into soil contained within the self-watering plant system.

8. The self-watering plant system of claim 1, wherein the wick holder is defined as non-linear.

9. The self-watering plant system of claim 1, wherein the wick holder is defined as U-shaped, such that the wick holder makes a 180-degree turn.

10. The self-watering plant system of claim 1, further comprising:
a first wick holder defined as linear; and
a second wick holder defined as non-linear;
wherein the self-watering plant system is thus configured for use above soil.

11. The self-watering plant system of claim 1, further comprising:
a means to apply and maintain a pressure on the at least one interchangeable wick at a location where the wick passes through an airspace between the liquid in the reservoir and the soil.

12. The self-watering plant system of claim 11, further comprising:
an adjustment knob, configured to adjust an amount of pressure, thereby to regulate the capillary action in the at least one interchangeable wick.

13. The self-watering plant system of claim 12, further comprising:
a bar which runs from the adjustment knob towards the at least one interchangeable wick.

14. The self-watering plant system of claim 12, wherein the self-watering plant system does not include a wick housing.

15. The self-watering plant system of claim 13, further comprising:
plurality of threads disposed on the bar, and a plurality of complementary threads disposed on adjacent edges of the planter, thereby configured to allow pressure to be applied or removed via a screw mechanism; and
an adjustment pointer, located at the end of the bar nearest the wick, that moves towards and away from the wick with the bar, thereby configured to apply and remove pressure, but not turn with the bar, thus configured to avoid damage to the wick.

16. The self-watering plant system of claim 13, further comprising:
a circular end that fits with a complementary circular end on the bar, configured to allow the two parts to spin separately; and
a non-circular circumference, and a non-circular complimentary passage within the planter, configured to prevent the adjustment pointer from spinning.

17. The self-watering plant system of claim 1, further comprising:
a cap configured to tightly seal the reservoir.

18. The self-watering plant system of claim 1, wherein the wick holder fits into a planter between the at least one interchangeable wick and the wick housing; contains a wick holder ingress opening which allows a portion of the wick to be exposed to liquid in a reservoir; contains a wick holder egress opening which allows a portion of the wick to be exposed to a soil medium; and is detachable from the planter.

19. The self-watering plant system of claim 1, wherein the wick holder is configured to surround a circumference of a portion of the at least one interchangeable wick and to modify an opening of the reservoir, as needed, to accommodate additional material surrounding the at least one interchangeable wick.

20. The self-watering plant system of claim 1, further comprising:
a second wick holder.

21. The self-watering plant system of claim 1, wherein the wick housing is additionally configured to house, one at a time, wicks that are varying degrees of thickness such that a correct wick thickness is selected and utilized based on water needs of a plant watered by the self watering plant system.
